(19) United States
(12) Patent Application Publication
(10) Pub. No.: US 2018/0252402 A1
(43) Pub. Date: Sep. 6, 2018

(54) PLASTIC HEAT SINK FOR LUMINAIRES

(71) Applicant: SABIC Global Technologies B.V., Bergen op Zoom (NL)

(72) Inventors: Arunachala PARAMESHWARA, Bangalore (IN); Venkatesha NARAYANASWAMY, Bangalore (IN); Remesh KUZHIKKALI, Bangalore (IN); Ramanand SINGH, Bangalore (IN)

(21) Appl. No.: 15/559,687

(22) PCT Filed: Mar. 17, 2016
(86) PCT No.: PCT/IB2016/051519

§ 371 Date: Sep. 19, 2017

(30) Foreign Application Priority Data
Mar. 20, 2015 (IN) 762/DEL/2015

(51) Int. Cl. F21V 29/74; F21V 29/80; F21V 29/87; F21V 23/00; F21V 29/503; F21K 9/90

(52) U.S. Cl. CPC F21V 29/74; F21V 29/80; F21V 29/87; F21V 5/048; F21V 29/503; F21K 9/90; F21V 23/006

(57) ABSTRACT

Luminaires are disclosed that are configured to emit LED illumination. The luminaires can include a plastic heat sink that can include different fin geometries that provide different heat dissipation properties.

### CROSS REFERENCE TO PRIOR APPLICATIONS

This application claims priority to Indian patent application no. 762/DEL/2015, filed on Mar. 20, 2015, the disclosure of which is incorporated by reference in its entirety.

### BACKGROUND

Luminaires are available in many shapes, sizes, and configurations. Modern luminaires can include light emitting diodes (LEDs) as opposed to traditional incandescent light bulbs for their high energy efficiency and longevity. Conventional LED-based luminaires employ metallic heat sinks that direct heat away from the LEDs during operation. However, metallic heat sinks are typically cast, which limits the configuration of the heat sink. For instance, in certain luminaires, the cast metallic heat sinks have limited geometric fin configurations.

### SUMMARY

In accordance with another aspect of the present disclosure, a heat sink can include a base that defines an inner surface configured to be placed in thermal communication with at least one LED, and an outer surface opposite the inner surface. The heat sink can further include a plurality of plastic fins project out from the outer surface from a proximal end to a distal end. Accordingly, at least a group of the plurality of fins defines a fin geometry that is selected from at least one of a group of available geometries including a linear geometry, an angled geometry, a radial geometry, a pin-shaped geometry, a pyramidal geometry, and a curved geometry.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description, is better understood when read in conjunction with the appended drawings. There is shown in the drawings example embodiments of various embodiments, however the present invention is not limited to the specific methods and instrumentalities disclosed. In the drawings:

FIG. 1A is a perspective view of a luminaire of one embodiment;

FIG. 2B is an exploded perspective view of the luminaire illustrated in FIG. 1A;

FIG. 2A is a perspective view of a heat sink of the luminaire illustrated in FIG. 1A, but including first and second portions in accordance with one embodiment;

FIG. 2B is a schematic exploded perspective view of the heat sink of the luminaire illustrated in FIG. 2A to illustrate the first and second portions;

FIG. 3A is a sectional end elevation view of a portion of the heat sink of a luminaire as illustrated in FIG. 1A, including a metallic material and a plastic material;

FIG. 3B is a sectional end elevation view similar to FIG. 3A, but showing the portion of the heat sink constructed in accordance with another embodiment;

FIG. 4A is a perspective view of a modular heat sink of a luminaire as illustrated in FIG. 1A in accordance with one embodiment;

FIG. 4B is a perspective view of the modular heat sink illustrated in FIG. 4A;

FIG. 5A is a perspective view of a modular side-by-side heat sink of a luminaire as illustrated in FIG. 1A in accordance with one embodiment;

FIG. 5B is a perspective view of the heat sink illustrated in FIG. 5A;

FIG. 6A is a perspective view of a heat sink of a luminaire as illustrated in FIG. 1A including fins having a linear fin geometry in accordance with one embodiment;

FIG. 6B is a top plan view of the heat sink illustrated in FIG. 6A;

FIG. 7A is a perspective view of a heat sink of a luminaire as illustrated in FIG. 1A but including fins having an angled fin geometry in accordance with another embodiment;

FIG. 7B is a top plan view of the heat sink illustrated in FIG. 15A;

FIG. 8A is a perspective view of a heat sink of a luminaire as illustrated in FIG. 1A but including fins having a radial fin geometry in accordance with another embodiment;

FIG. 8B is a top plan view of the heat sink illustrated in FIG. 8A;

FIG. 9A is a perspective view of a heat sink of a luminaire as illustrated in FIG. 1A but including fins having a curved fin geometry in accordance with another embodiment;

FIG. 9B is a top plan view of the heat sink illustrated in FIG. 9A;

FIG. 10A is a sectional side elevation view of the fins of a heat sink of a luminaire as illustrated in FIG. 1A in accordance with one embodiment;

FIG. 10B is a sectional side elevation view of the fins of a heat sink of the luminaire illustrated in FIG. 1A, in accordance with another embodiment;

FIG. 11 is a perspective view of a heat sink of a luminaire illustrated in FIG. 1A but including fins having a pin-shaped fin geometry in accordance with another embodiment; and

FIG. 12 is a perspective view of a heat sink of a luminaire as illustrated in FIG. 1A but including fins having a pyramidal fin geometry in accordance with another embodiment.

### DETAILED DESCRIPTION

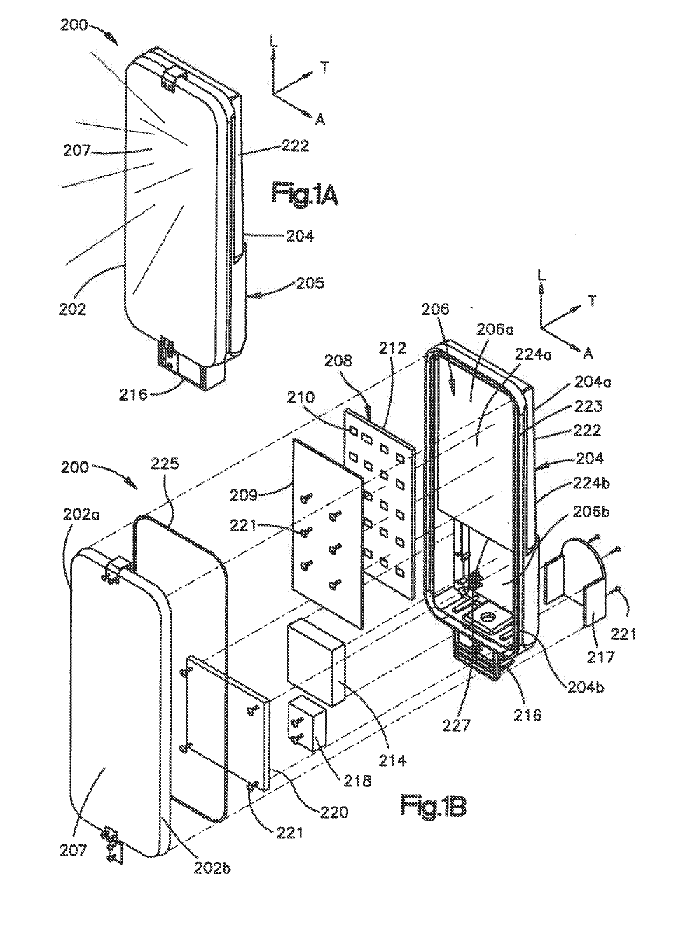

Referring now to FIGS. 1A-1B, a luminaire 200 constructed in accordance with one embodiment includes a housing component 202 and a heat sink 204. The heat sink 204 is at least partially supported by the housing component 202 such that the luminaire 200 defines an interior space 206 that is disposed between the housing component 202 the heat sink 204. For instance, the interior space 206 can be defined by the housing component 202 and the heat sink 204. Alternatively, the heat sink 204 can be supported by an intermediate structure that, in turn, is attached to the housing component 202. The housing component 202 and the heat sink 204, or alternatively or additionally the intermediate structure, can combine so as to define a housing 205 that substantially encloses the interior space 206.

Reference herein to the housing 205 is used herein to refer to one or both of the housing component 202 and the heat sink 204. Alternatively or additionally, reference herein to the housing 205 can include the intermediate structure. Further, reference to the interior space 206 can refer to one or both of an interior space defined by the housing component 202, and an interior space defined by the heat sink 204. It should be appreciated, in this regard, that the interior space 206 can be defined by one of the heat sink 204 and the housing component 202, such that the interior space is closed by the other of the heat sink 204 and the housing component 202. Alternatively or additionally, reference to the interior space 206 can refer to an interior space defined by the intermediate structure.

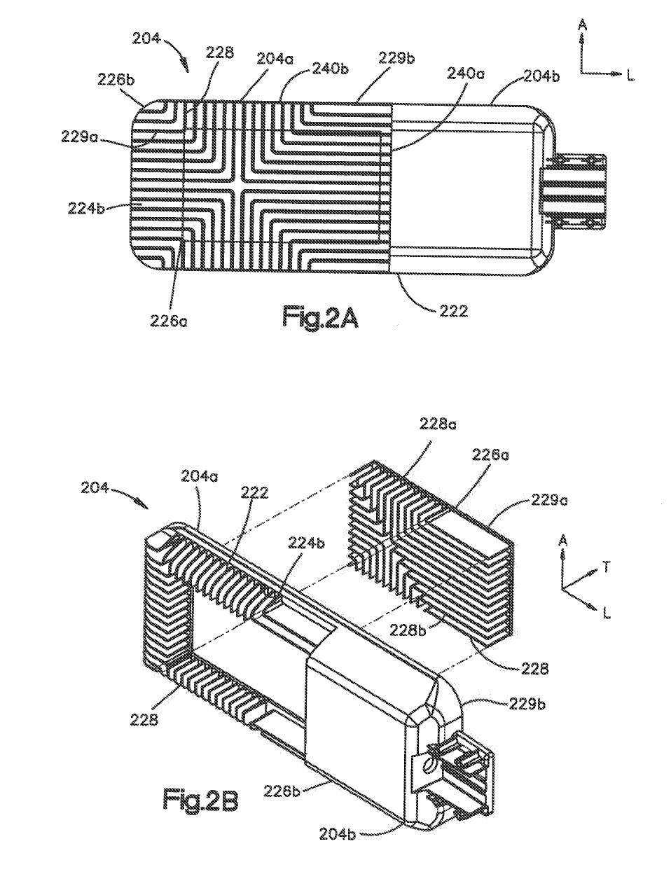

In one example, the heat sink 204 can include a base 222 and at least one side wall 223 that extends from the base 222 along a transverse direction T. For instance, the at least one side wall 223 can extend from an outer perimeter of the base 222. The base 222 and the side wall 223 can combine so as to define at least a portion of the interior space 206. For instance, the base 222 defines an inner surface 224a and an outer surface 224b (see FIG. 2A) opposite the inner surface along the transverse direction T. The side wall 223 can extend from the base 222 in a direction defined from the outer surface 224b to the inner surface 224a. The side wall 223 can be attached to the housing component 202 such that the heat sink 204 and the housing component 202 combine so as to substantially enclose the interior space 206. Thus, the interior space 206 can be defined by the housing component 202, the inner surface 224a of the heat sink 204, and the at least one side wall 223 of the heat sink 204. The luminaire 200 can further include a gasket 225 disposed at an interface of the at least one side wall 223 and the housing component 202, so as to seal the interface. In one example, the gasket 225 can be configured as an elastomeric gasket. Further, the housing 205 can be devoid of open apertures that extend into the interior space 206. Accordingly, the luminaire 200 can be sealed and suitable for outdoor use. In one example, the luminaire 200 can be configured for use as an outdoor street light.

The housing component 202 includes a light source, and a lens 207 in optical communication with the light source such that the light source is configured to emit light through the lens 207. Thus, the lens 207 can be at least translucent, and in some embodiments can be substantially transparent. In particular, the luminaire can include an LED panel 208 that is disposed in the interior space 206. Thus, the light source can be configured as at least one LED 210 that is supported by a substrate 212 of the LED panel. The at least one LED 210 is configured to produce illumination, such that at least a portion of the illumination is directed through the lens 207. In one example, the at least one LED 210 includes a plurality of LEDs 210 supported by the substrate 212.

The luminaire 200 further includes a driver 214 that is supported in the interior space 206 and is configured to receive input electrical power from an electrical power source, and in turn output electrical power. The driver 214 is in electrical communication with the LED panel 208, such that the at least one LED 210 is configured to receive the output electrical power and, in response, produce illumination. The at least one LED 210 can be configured as a red-green-blue (RGB) LED or as any suitable alternative LED as desired. In one example, the housing 205 can define an interface 216, which is configured to mate with a complementary interface in electrical communication with an external electrical power source. The interface 216 can be configured as a receptacle at least partially defined by the housing 205, such as the heat sink 204, and an end cover 217 that is secured to the heat sink 204 that is configured to partially define the interface 216. The luminaire 200 can include an electrical connector 218 disposed in the interior 206 at a location proximate to the interface 216. The electrical connector 218 is configured to mate with a complementary electrical connector of the electrical power source so as to receive the input external electrical power. The electrical connector 218 can further be in electrical communication with the driver 214 so as to allow transmission of the input electrical power to the driver 214. Alternatively, the luminaire 200 can include an onboard electrical power source, such as an electrochemical cell.

With continuing reference to FIGS. 1A-1B, the base 222, and thus the heat sink 204, can define a first end 204a and a second end 204b opposite the first end 204a along a longitudinal direction L that is substantially perpendicular to the transverse direction. Similarly, the housing component 202 can define a first end 202a and a second end 202b opposite the first end 202a along the longitudinal direction L. The first end 202a can be aligned with the first end 204a along the transverse direction T. Similarly, the second end 202b can be aligned with the second end 204b along the transverse direction T. The base 222 can define a length along the longitudinal direction L, and a width along a lateral direction A that is perpendicular to the longitudinal direction L. In one example, the length can be greater than the width. The first end 204a can define an LED compartment 206a of the interior space 206 that is configured to retain the LED panel 208. The LED panel 208 can be supported in the interior 206, and in particular in the LED compartment 206a, such that the inner surface 224a faces the LED panel 208 and is in thermal communication with the at least one LED 210. Thus, the inner surface 224a is configured to receive heat from the at least one LED 210 during operation. The luminaire 200 can further include a secondary lens 209 that is disposed between the LED panel 208 and the lens 207, and is configured to shape or otherwise condition the illumination as desired. Thus, the lens 207 can be disposed at the first end 204a of the housing component 202.

The second end 204b can define a driver compartment 206b of the interior space 206 that is configured to retain the driver 214. Further, the driver compartment 206b can retain the electrical connector 218. The base 222 can define a step 227 between the LED compartment 206a and the driver compartment 206b, such that the driver compartment 206b has a depth in the transverse direction T that is greater than the depth of the LED compartment 206a. The luminaire 200 can further include a driver cover 220 that is configured to secure the driver 214 and the electrical connector 218 in the interior space 206, and in particular in the driver compartment 206b The driver cover 220 can be secured, for instance via fasteners 221 to the heat sink so as to enclose the driver compartment 206b. The driver 214 and the electrical connector 218 can each be secured either or both of to the heat sink 204 and the driver cover 220.

Referring also to FIGS. 2A-2B, the heat sink 204 can define a plurality of fins 228 that project out from the outer surface 224b from respective proximal ends 228a to respective distal ends 228b. In one example, the distal ends 228b can be spaced from the respective proximal ends 228a along a direction that is substantially normal to the outer surface 224b. In one example, the fins 228 can be continuous from their respective proximal ends 228a to their respective distal ends 228b. The distal ends 228b of the fins 228 can be separate from the distal ends 228b of the other fins 228, and can thus be referred to as free ends.

For instance, the fins 228 can project out from the outer surface 224b at the first end 204a of the heat sink 204. Additionally, the fins 228 can project out from at least a portion up to an entirety of the outer surface 224b at the second end 204b of the heat sink 204. Alternatively or additionally, at least a portion up to an entirety the outer surface 224b at the second end 204b of the heat sink 204 can be substantially smooth, that is devoid of the fins 228. In one example, the outer surface 224b at the second end 204b can be substantially coplanar with the distal ends 228b of the fins 228 at the first end 204a. Alternatively, the distal ends 228b of the fins 228 at the first end 204a can be recessed with respect to the outer surface 224b at the second end 204b. Alternatively still, the outer surface 224b at the second end 204b can be recessed with respect to the distal ends 228b of the fins 228 at the first end 204a. Because the lens 207 is disposed at least at the first end 202a of the housing component 202, and the LED panel 208 is disposed in the LED compartment 206a, the LED substrate 212 of the LED panel 208 can be disposed between the lens 207 and at least one of the fins 228, for instance, with respect to the transverse direction T. Accordingly, a straight line that extends through the lens 207 and the LED panel 208 can also pass through one of the fins 228. The straight line can be oriented along the transverse direction T.

The heat sink 204 can be manufactured such that the fins 228 can define a geometry among a plurality of available geometries. For instance, at least a portion of the heat sink 204 can be made from plastic. In one example, the outer surface 224b and the fins 228 can be made from a thermally conductive plastic. Thus, the fins 228 can be manufactured with geometries that differ from the geometries of fins of conventional heat sinks that are made of cast metal. For instance, the thermally conductive plastic can be a thermoplastic. At least the outer surface 224b and the fins 228 can be a molded plastic part.

Thus, the fins 228 and the outer surface 224b can define a monolithic homogeneous component. The monolithic homogeneous component can be a plastic component, that can be a first plastic material 229a. For instance, the first plastic material 229a can be as described above. Thus, the first plastic material 229a can be thermoplastic. The first plastic material 229a can be thermally conductive, and thus can have a thermal conductivity sufficient to allow the heat sink 204 to remove a sufficient amount of heat from the LED panel 208 to thereby substantially assist in maintaining the at least one LED 210 at or below a desired LED junction temperature. In one example, the LED junction temperature can be 90 degrees Celsius. In one embodiment, the first plastic material 229a can have a thermal conductivity in-plane of a 60 mm (millimeters)×60 mm×3 mm plaque in a range between and including approximately 1 W/m-k (watts per meter-kelvin) and approximately 20 W/m-k, as measured in accordance with Standard ISO 22007-2 (2008). In one example, the in-plane thermal conductivity can be in a range between and including approximately 1.5 W/M-k and approximately 18.0 W/m-k, such as approximately 1.5 W/m-k, approximately 1.9 W/m-k, approximately 3.3 W/m-k, approximately 3.4 W/m-k, or approximately 18 W/m-k as measured in accordance with Standard ISO 22007-2 (2008). The first plastic material 229a can have a thermal conductivity through-plane of the 60 mm×60 mm×3 mm plaque in a range between and including 0.5 and 5 W/m-k, such as approximately 2.0 W/m-k as measured in accordance with Standard ISO 22007-2 (2008). For instance, the through-plane thermal conductivity can be in the range between and including 0.8 W/m-k and 1.5 W/m-k, such as approximately 1.3 W/m-k as measured in accordance with Standard ISO 22007-2 (2008). The root mean square (RMS) value of the in-plane and through-plane conductivities as described above can be in a range between and including approximately 1.2 W/m-k and approximately 12.8 W/m-K. The first plastic material can have a melt temperature between approximately 320 degrees Celsius and 350 degrees Celsius. Both in-plane and through-plane thermal conductivities identified herein can be measured in accordance with Standard ISO 22007-2 (2008). Approximate thermal conductivity values can account for typical variations in such measurements. The first plastic material 229a can have a melt temperature between approximately 320 degrees Celsius and 350 degrees Celsius. The first plastic material 229a can be electrically insulative or electrically conductive as desired. One example of such a first plastic material 229a is Konduit™ plastic material commercially available from SABIC, having a principal place of business in Riyadh, Saudi Arabia.

In one example, the monolithic homogeneous component can be injection molded. For instance, an entirety of the base 222 can be molded from the first plastic as a monolithic homogeneous component from the inner surface 224a to the outer surface 224b at least at the first end 204a. Further, an entirety of the base 222 can be molded from the first plastic as a monolithic homogeneous component from the inner surface 224a to the outer surface 224b, including the first end 204a and the second end 204b. Further still, an entirety of the heat sink 204 can be molded from the first plastic as a monolithic homogeneous component including the base 222 and the at least one side wall 223.

As illustrated in FIGS. 2A-2B, a first portion 226a of the heat sink 204 can comprise the first plastic material 229a, and a second portion 226b of the heat sink 204 can comprise a second material 229b that is different than the first plastic material 229a. In one example, the second material 229b can be a plastic material, such as a thermoplastic. The second material 229b have a thermal conductivity less than the first plastic material 229a. Further, the second material 229b can be selected to be less expensive than the first material. In one example, the second material 229b can be a polycarbonate or a Polycarbonate/Acrylonitrile Butadiene Styrene (PC/ABS) as described above. It should be appreciated, of course, that the first plastic material 229a and second material 229b can define any suitable plastic material as desired.

The first portion 226a of the heat sink 204 can be at least partially disposed at the first end 204a. Similarly, the second portion 226b of the heat sink 204 can be at least partially disposed at the first end 204a. For instance, at least some up to all of the first portion 226a can be located at a region of the heat sink 204 that is in alignment with the LED panel 208 along the transverse direction T. At least some up to all of the second portion 226b can be located at a region of the heat sink 204 that is out of alignment with the LED panel 208 along the transverse direction T. It can be said that, on average, the first portion 226a is more aligned than the second portion 226b with the LEDs 210 along the transverse direction T. Accordingly, the first portion 226a has a thermal conductivity greater than the second portion 226b. In one example, at least a portion of the first portion 226a is surrounded by the second portion 226b with respect to a plane that includes the longitudinal direction L and the lateral direction A. For instance, an entirety of the first portion 226a can be surrounded by the second portion 226b with respect to a plane that includes the longitudinal direction L and the lateral direction A.

It is recognized that the fins 228 can define an outer surface area that is exposed to the ambient environment to facilitate heat transfer from the luminaire 200 into the ambient environment. In one example, all of the fins 228 can disposed at the first portion 226a. Alternatively, a portion of the fins 228 can be disposed at the second portion 226b. Because the first portion 226a is more aligned with the LEDs 210 than the second portion 226b is aligned with the LEDs 210, the LEDs, the first portion 226a carries more of the surface area of the fins than the second portion 226b.

The second portion 226b can be at least partially or entirely defined at the first end 204a. In one example, the second end 204b can also be defined by the second portion 226b. The first portion 226a can be monolithic with the second portion 226b. For instance, the first portion 226a can be co-injected with the second portion 226b. While FIG. 2B shows the first portion 226a exploded from the second portion 226b, this is for illustration purposes to identify the first portion 226a, it being appreciated that the first and second portions 226a and 204b can be monolithic with each other. Alternatively, the first portion 226a can be attached to the second portion 226b. The first portion 226a and the second portion 226b can be monolithic with each other at the first end 204a. The first end 204a can be monolithic with the second end 204b. In one example, the first end 204a can be homogenous with the second end 204b. Alternatively, the first end 204a can be co-injected with the second end 204b,

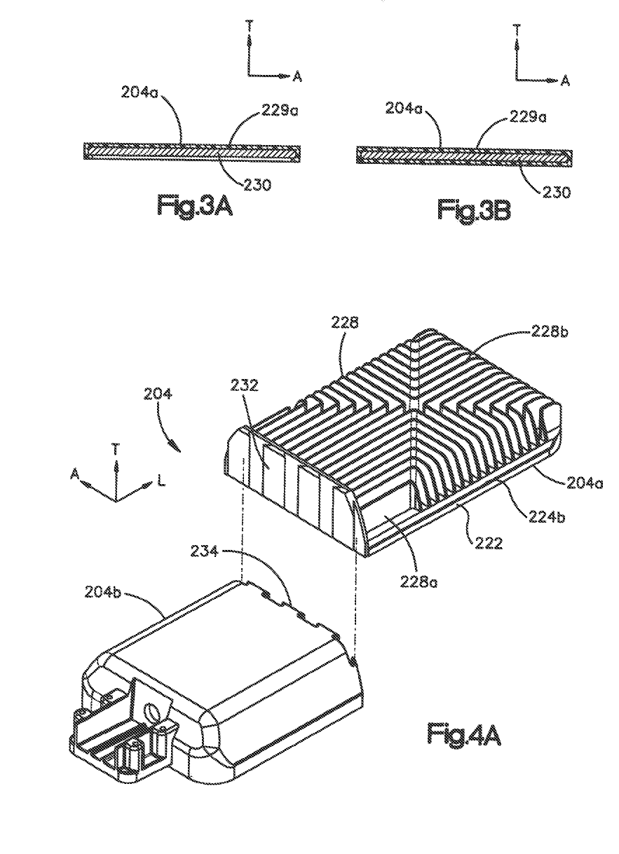

Referring now to FIGS. 3A-3B, the heat sink 204 can further include an electrically conductive material, such as a metal 230. The metal 230 can be configured as a metal plate. The metal plate can be oriented along a plane that is defined by the lateral direction A and the longitudinal direction L. In one example, the first end 204a can further include the electrically conductive material. For instance, the first end 204a can include the first plastic material and the metal 230. As illustrated in FIG. 3A, at least a portion of the inner surface 224a up to an entirety of the inner surface 224a can be defined by the metal 230. The outer surface 224b can be defined by the first plastic material 229a. As described above, the fins 228 can project out from the outer surface 224b, and can be homogenous with the outer surface 224b. In one example, the metal 230 can be overmolded by the first plastic material 229a. Alternatively, the metal 230 can be inserted into the plastic material 229a. Alternatively, as illustrated in FIG. 3B, the metal 230 can be substantially encapsulated by the first plastic material 229a. Accordingly, the first plastic material 229a can define both the inner surface 224a and the outer surface 224b. It will thus be appreciated that the base 222 can comprise the metal. For instance, the first end 204a can comprise the metal. In an example whereby the heat sink 204 defines the first portion 226a and the second portion 226b, the first portion 226a can comprise the metal.

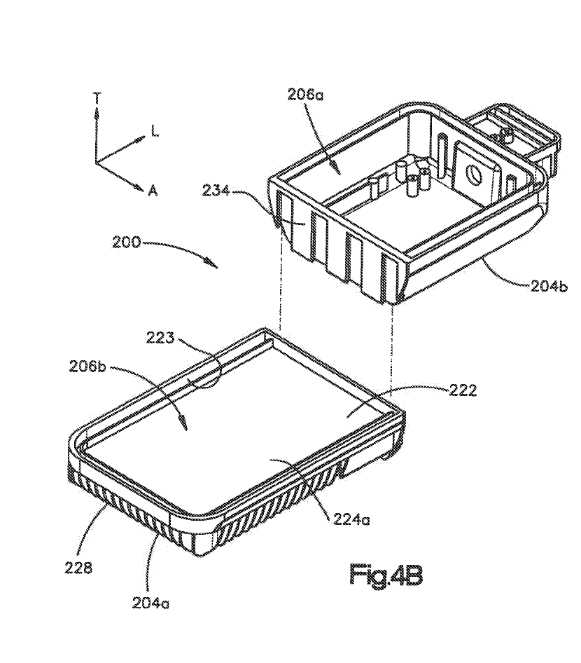

Referring now to FIGS. 4A-4B, the second end 204b can be separate from the first end 204a and configured to be attached to the first end 204a. In one example, the first and second ends 204a and 226b can be removably attached to each other. For instance, the first end 204a can include at least one first attachment member 232, and the second end 204b can include at least one second attachment member 234 that is configured to mate with the first attachment member 232 so as to attach the first end 204a to the second end 204b. The attachment members 232 and 234 can be constructed in accordance with any suitable embodiment as desired. Further, the attachment members 232 and 234 can be supported by respective surfaces of the first and second ends 204a and 226b that face each other. In one example, the attachment members 232 and 234 can define a dovetail joint. The first and second attachment members can mate by movement of at least one or both of the first and second ends 204a and 226b with respect to the other of the first and second ends 204a and 226b along a direction perpendicular to the longitudinal direction L. For instance, the first and second attachment members 223 and 234 can mate by movement of at least one or both of the first and second ends 204a and 226b with respect to the other of the first and second ends 204a and 226b along the transverse direction T. Thus, the second end 204b can be made from a different material than the first end 204a. For instance, the second end 204b can be electrically conductive. In one example, the second end 204b can be metallic.

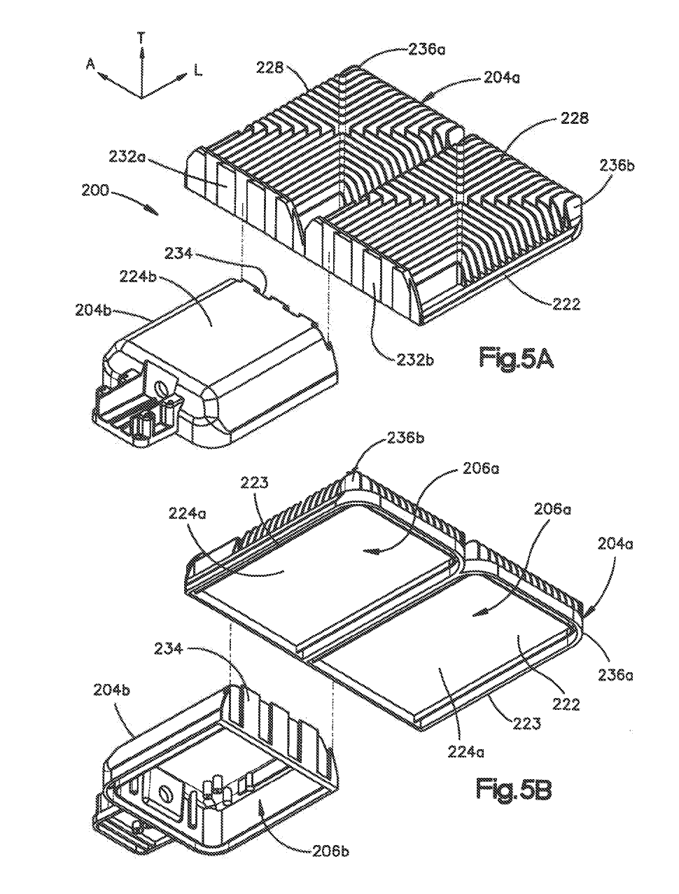

Referring now to FIGS. 5A-5B, the base 222 and the at least one side wall 223 as described above can be referred to as a first base, and the at least one side wall 223 can be referred to as a first at least one side wall. The first end 204a of the heat sink 204 can include first and second sides 236a and 236b that are spaced from each other along the lateral direction A. The first base 222 and the first at least one side wall 223 can be disposed at the first side 236a. The second side 236b can define a second base 222 and a second at least one side wall 223. The first side 236a can include first ones of the plurality of fins 228 that project from the outer surface 224b of the first side 236a. Similarly, the second side 236b can include second ones of the plurality of fins 228 that project from the outer surface 224b of the second side 236b. The first side 236a can be configured to attach to a first housing component 202, and the second side 236b can be configured to attach to a second housing component 202. The first and second sides 236a and 236b can be monolithic with each other, or can alternatively be attached to each other in any manner as desired.

Each of the first and second sides 236a and 236b can be configured to be attached to the second end 204b. For instance, the first side 236a can include at least one first attachment member 232a, and the second side 236b can includes at least one second attachment member 232b. The second end 204b can include at least a pair of attachment members 343 that are configured to mate with respective ones of the first and second attachment members 232a and 233b, so as to attach each of the first and second sides 236a and 236b to the second end 204b. The attachment members 232a-b and 234 can be constructed in accordance with any suitable embodiment as desired. Further, the at least one first attachment member 232a and the attachment member 234 of the second end 204b can be supported by respective surfaces of the first side 236a and the second end 204b that face each other. Similarly, the at least one second attachment member 232b and the attachment member 234 of the second end 204b can be supported by respective surfaces of the second side 236a and the second end 204b that face each other. In one example, the attachment members 232a and 234, and 232b and 234, can define respective dovetail joints.

The at least one first attachment member 232a and the attachment member 234 of the second end 204b can mate by movement of at least one or both of the first side 236a and the second end 204b with respect to the other of the first side 236a and the second end 204b along a direction perpendicular to the longitudinal direction L. For instance, the at least one first attachment member 232a and the attachment member 234 of the second end 204b can mate by movement of at least one or both of the first side 236a and the second end 204b with respect to the other of the first side 236a and the second end 204b along the transverse direction T. Similarly, the at least one second attachment member 232b and the attachment member 234 of the second end 204b can mate by movement of at least one or both of the second side 236b and the second end 204b with respect to the other of the second side 236b and the second end 204b along a direction perpendicular to the longitudinal direction L. For instance, the at least one second attachment member 232b and the attachment member 234 of the second end 204b can mate by movement of at least one or both of the second side 236b and the second end 204b with respect to the other of the second side 236b and the second end 204b along the transverse direction T. As described above, the second side 236b can be supported by the first side 236a. For instance, the first and second sides 236a and 236b can be attached to each other. Alternatively, the first and second sides 236a and 236b can be monolithic with each other. Thus, the at least one first attachment member 232a and the at least one second member 232b can mate substantially simultaneously with the attachment member 234 of the second end 204b.

The second end 204b can at least partially define the driver compartment 206b as described above. Further, each of the first and second sides 236a and 236b can at least partially define the LED compartment 206a, as described above, each having a respective LED panel 208. Each of the LED panels 208 can be in electrical communication with the driver 214 so as to receive a respective portion of the output electrical power so as to produce illumination from the respective LEDs 210. The first end 202a of the housing component 202 can similarly define a first side and a second side spaced from the first side along the lateral direction A. Thus, the first side 236a of the heat sink 204 is aligned with the first side of the housing component 202, and the second side 236b of the heat sink 204 is aligned with the second side of the housing component 202. Further, the second end 204b of the heat sink 204 is aligned with the second end 202b of the housing component 202.

The first side of the housing component 202 includes a first lens aligned with a first LED panel 208 of the first side 236a, and the second side of the housing component 202 includes a second lens aligned with a second LED panel 208 of the second side 236b. The first LED panel can be disposed in the interior space 206 between the first side of the housing component 202 and the first side 236a of the heat sink 204. The first LED panel can include at least one first LED 210 that is in electrical communication with the driver 214 and configured to produce illumination, such that at least a portion of the illumination is directed through the first lens. Similarly, the second LED panel 208 can be disposed in the interior space 206 between the second side of the housing component 202 and the second side 236b of the heat sink 204. The second LED panel 208 can include at least one first LED 210 that is in electrical communication with the driver 214 and configured to produce illumination, such that at least a portion of the illumination is directed through the second lens. In one example, a straight line extending through the first lens and the first LED panel also passes through a fin of the first side of the heat sink. The straight line can be oriented along the transverse direction T. Further, a second straight line extending through the second lens and the second LED panel also passes through a fin of the second side of the heat sink. The second straight line can be oriented along the transverse direction T. It is recognized that the first and second lenses can be separate lenses, or integrated into a monolithic lens having regions that define the first and second lenses.

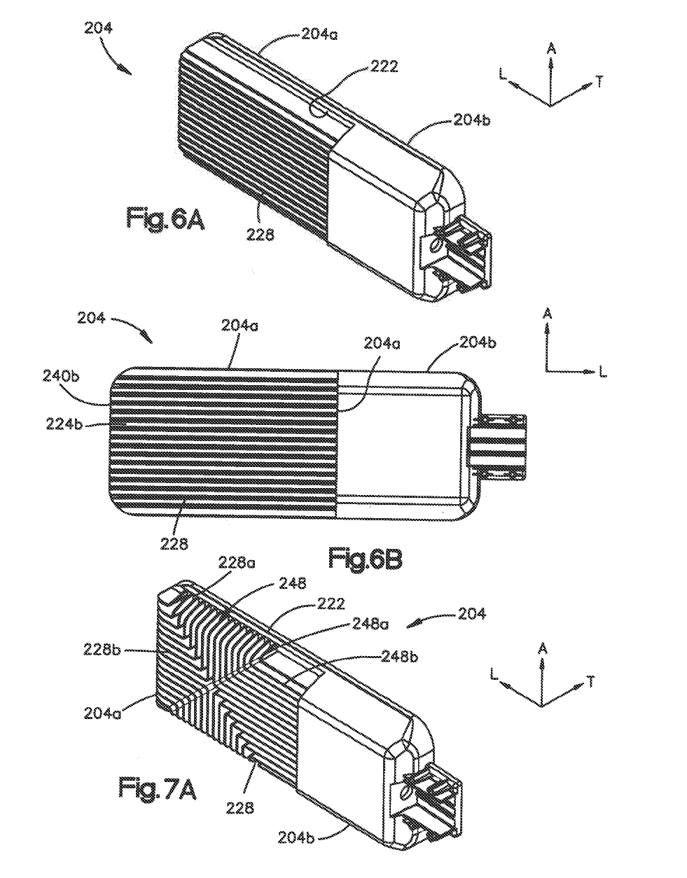

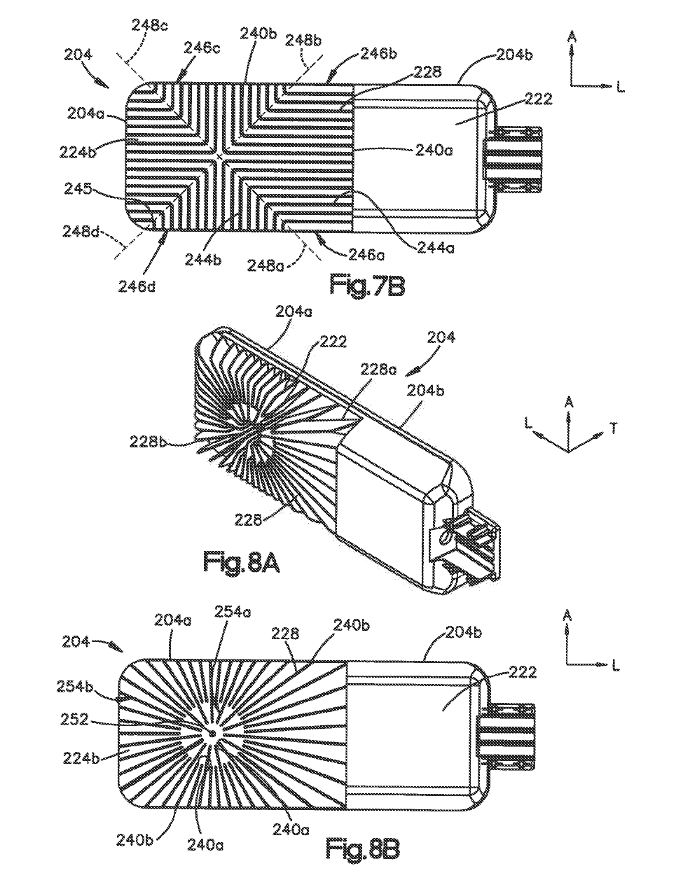

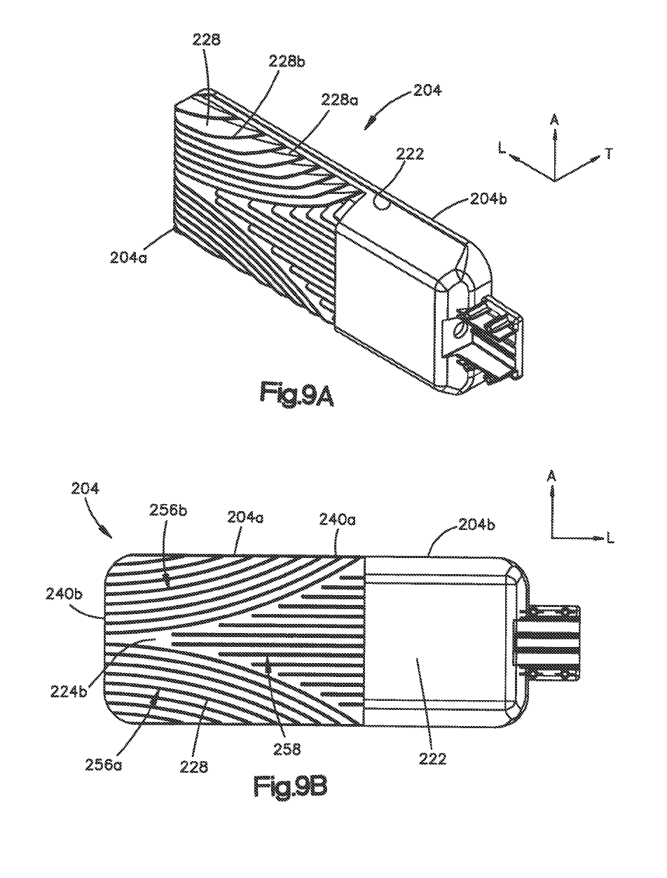

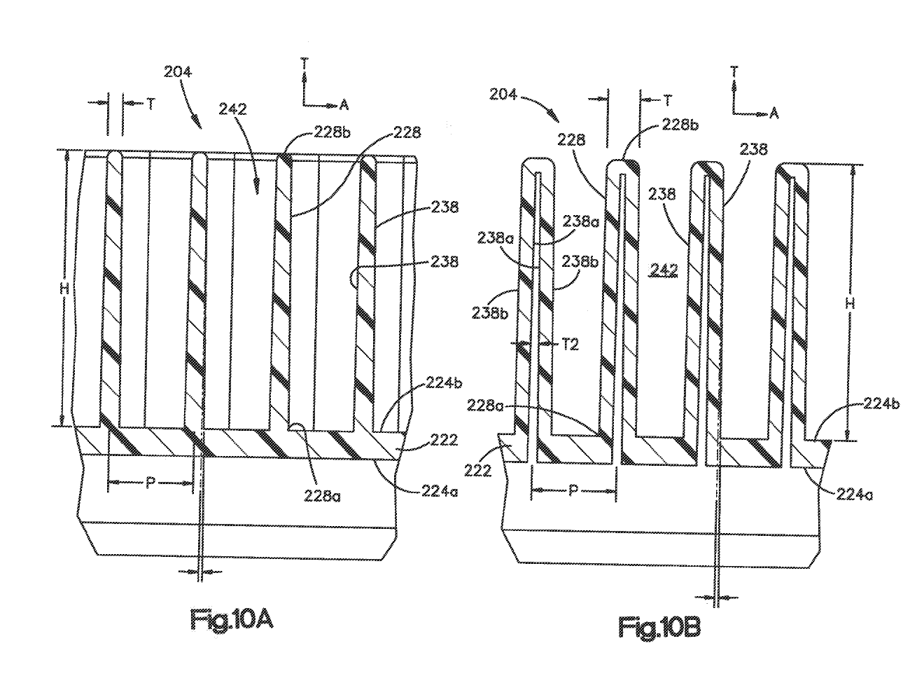

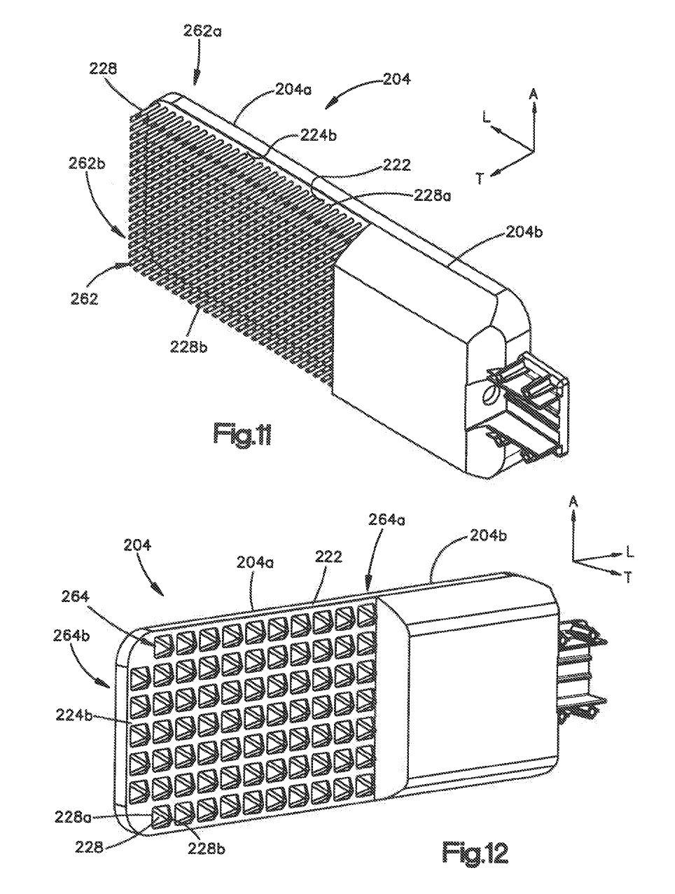

Referring now to FIGS. 6A-12 generally, and as described above, the heat sink 204 can be manufactured such that at least one group of the plurality of fins 228 can define any geometry as desired among a plurality of available geometries. The group of available geometries can include a linear geometry (FIGS. 6A-6B), an angled geometry (FIGS. 7A-7B), a radial geometry (FIGS. 8A-8B), a curved geometry (FIGS. 9A-9B), a pin-shaped geometry (FIG. 11), and a pyramidal geometry (FIG. 12). Further, the fins 228 can be solid (FIG. 10A) or hollow (FIG. 10B). As described above, a proximal end 228a of each of the fins 228 extends out from the base 222 to a distal end 228b. The fins can each define at least one side wall 238 (see FIGS. 10A-10B) that extend from the proximal end 228a to the distal end 228b. Each of the distal ends 228b can extend along a direction of elongation from a first end 240a of the fin 228 to a second end 240b of the fin opposite the first end 240a. The linear geometry, the angled geometry, the curved geometry, and the radial geometry can be defined by the direction of elongation of the distal end 228b. The pin-shaped geometry and the pyramidal geometry can be defined by a direction of extension of the at least one side wall 238 from the proximal end 228a to the distal end 228b. In one example, each of the fins 228 can be continuous from the first end 240a to the second end 240b. Further, the heat sink 204 can define respective gaps 242 (see FIGS. 10A-10B) between adjacent ones of the plurality of fins 228. The air gaps 242 can be open at the perimeter of the base 222, and thus at the perimeter of the heat sink 204.

The plurality of fins 228 can include a single group having a single geometry from the group of available geometries, or more than one group each having respective different geometries selected from the group of available geometries. In one example, a first group of the plurality of fins 228 can define a first fin geometry that is selected from the group of available geometries, and a second group of the plurality of fins 228 that defines a second geometry that is different than the first geometry and is selected from the group of available geometries. One or more groups can be defined, for instance, at the outer surface 224b of the base 222 at a location that is in thermal communication with a common LED panel 208 (see FIGS. 9A-9B). In one example, one group can be defined by first portion 226a of the base 222, and another group can be defined by the second portion 226b of the base 222 (described above with respect to FIGS. 2A-2B). Alternatively or additionally, one or more groups can be disposed at the first side 236a, and another one or more groups can be disposed at the second side 236b (described above with respect to FIGS. 5A-5B).

Referring now to FIGS. 6A-6B, the at least one group of the plurality of fins 228 can define the linear geometry so as to define linear fins. For instance, the distal ends 228b are elongate along a linear path from the respective first ends 240a to the respective second ends 240b. The linear path can be oriented along any direction as desired. In one example, the linear path is oriented along the longitudinal direction L. In one example, the linear paths defined by the distal ends 228b of the fins 228 that define the linear geometry can be parallel to each other. The distal ends 228b can extend from a perimeter at the first end 204a of the base 222 to the second end 204b. The fins 228 can terminate at the second end 204b. Adjacent ones of the fins 228 can be spaced from each other along the lateral direction A from a first side of the base 222 to a second side of the base 222. The first and second sides can be disposed at the outer perimeter of the base 222. Accordingly, the fins 228 can define a footprint that covers a substantial entirety of the outer surface 224b of the base 222.

Referring now to FIGS. 7A-7B, the at least one group of the plurality of fins 228 can define the angled geometry. In particular, the distal ends 228b can define a first portion 244a and a second portion 244b that extends from the first portion 244a at a direction angularly offset with respect to the first portion 244a. The first portion 244a of each of the fins 228 can be adjoined to the second portion 244b at a junction 245. In one example, the second portion 244b can be substantially perpendicular to the first portion 244a. The first portions 244a can be parallel to each other. Alternatively, the first portions 244a can converge or diverge from each other with respect to a direction from the second end 204b to the second end 204b. In one example, the first portions 244a can be oriented along the longitudinal direction L. The second portions 244b can be parallel to each other. Alternatively, the second portions 244b can converge or diverge from each other with respect to the lateral direction A. The second portions 244b can be parallel to each other. In one example, the second portions 244b can be oriented along the lateral direction A.

The first portions 244a of at least some of the fins 228 can have different first lengths from the respective first ends 240a to the second portions 244b. Similarly, the second portions 244b of at least some of the fins 228 can have different second lengths from the respective first ends first portions 244b to the second ends 240b. For instance, the first lengths can increase in a select direction. The select direction can be oriented along the lateral direction A. In one example, the fins 228 can define a first region 246a whereby the first lengths increase in the select direction. The fins 228 can define a second 246b region adjacent the first region. In the second region 246b, the first lengths can decrease in the select direction. In this regard, the first lengths can define an apex that is disposed at an interface of the first and second regions 246a and 246b. The apex be at a midpoint of the fins 228 with respect to the lateral direction A, or can be alternatively positioned as desired.

It should thus be appreciated that the fins 228 of the first region 246a are spaced from each other in the select direction. The second lengths of fins 228 of the first region 246a that are spaced from each other in the select direction can define increasing respective second lengths. Further, the fins 228 of the second region 246b are spaced from each other in the select direction. The second lengths of fins 228 of the second region 246b that are spaced from each other in the select direction can define decreasing respective second lengths.

The junctions 245 at the first region 246a can define a first straight line 248a, and the junctions 245 at the second region 246b can define a second straight line 248b. The first and second straight lines 248a and 248b can intersect each other. At least one or both of the first and second straight lines 248a and 248b can be oblique with respect to the outer perimeter of the heat sink. The group of the plurality of fins 228 can further define a third region 246c of fins 228 that is adjacent the second region 246b, and a fourth region 246d of fins 228 that is adjacent the first and third regions 246a and 246c. The third and fourth regions 246c and 246d define respective third and fourth straight lines 248c and 248d defined by the respective junctions 245. The first and third straight lines 248a and 248c can be co-linear, and the second and fourth straight 248b and 248d lines can be co-linear. Thus, at least one or both of the third and fourth straight lines 248c and 248d can be oblique with respect to the outer perimeter of the base 222. The first, second, third, and fourth lines 248a-248d can have equal lengths or different lengths as desired. The regions 244a-244d can be configured such that they do not include a fin among the plurality of fins 228 whereby the first and second portions 244a and 244b have equal lengths.

Referring now to FIGS. 8A-8B, the at least one group of the plurality of fins 228 can define the radial geometry so as to define radial fins. The distal ends 228b of the radial fins can each be elongate along respective lines 250 that extend from the respective first ends 240a to the respective second ends 240b. Thus, the distal ends 228b can extend along a straight path from the respective first end 240a to the respective second end 240b. At least some up to all of the lines 250 can intersect each other. All of the lines 250 can extend from a common central location, which can define a common central point 252, such that the lines 250 intersect each other at the central point 252. The first and second ends 240a and 240b can be arranged such that the first end 240a is closer to the central location as compared to the second end 240b. The distal ends 228b can be spaced from the central location along a radial direction.

The radial fins can be arranged in at least one row, such as a plurality of rows. Each row can be defined by a distance from the first end 240a to the central location along the radial direction. For instance, along a first row 254a, the first ends 240a can define a first distance from the common center along the radial direction. Along a second row 254b, the first ends 240a can define a second distance from the common center along the radial direction. The second distance can be greater than the first distance. In one example, the first distance of all radial fins in the first row 254a can be the same, and the second distance of all radial fins in the second row 254b can be the same. Thus, the first ends 240a of the first row 254a can be aligned along a respective circle. Similarly, the first ends 240a of the second row 254b can be aligned along a respective circle.

The distal ends 228b of the radial fins can be circumferentially spaced from each other. For instance, adjacent ones of the radial fins can be angularly spaced from each other between approximately 4 degrees and approximately 10 degrees. Thus, the at least one group of radial fins can include any number of radial fins as desired, for instance between and including 36 and 90 radial fins. The distal ends 228b of the radial fins can be circumferentially equidistantly spaced from each other. The radial fins of the first row 254a can be arranged circumferentially with the radial fins of the second row 254b in a continuous pattern. For instance the radial fins of the first row 254a can be alternatingly arranged circumferentially with the radial fins of the second row 254b. Alternatively, more than one, such as a pair, of the fins 228 of the second row 254b can be disposed between adjacent ones of the fins 228 of the first row 254a. The second ends 240b of the radial fins of the first and second rows 254a and 254b can be disposed at the outer perimeter of the first end 204a of the heat sink 204. Thus, at least some of the second ends 240b of the radial fins can be disposed at the outer perimeter of the outer surface 224b. Accordingly, the respective lengths from the first end 240a to the second end 240b of the distal ends 228b of adjacent ones of the radial fins can be different from each other.

Referring now to FIGS. 9A-9B, the at least one group of the plurality of fins 228 can define the curved geometry so as to define curved fins. In particular, the distal ends 228b of the curved fins can extend along a curved path between the respective first ends 240a to the respective second ends 240b. In one example, the distal ends 228b of the curved fins can extend along a curved path from the respective first ends 240a to the respective second ends 240b. For instance, the curved fins can extend longer along the longitudinal direction L than the lateral direction A. The distal ends 228b of the curved fins can, for instance, define a variable curvature between the respective first ends 240a and the respective second ends 240b. At least a portion up to an entirety of the distal ends 228b of at least some of the curved fins can be parallel to each other along their lengths between the first ends 240a and the second ends 240b. For instance, at least a portion up to an entirety of the distal ends 228b of at least some of the curved fins can be parallel to each other along their lengths from the first ends 240a to the second ends 240b.

The curved fins can include first ones 256a of curved fins and second ones 256b of curved fins. The distal ends 228b of the first ones 256a of curved fins can diverge from the distal ends 228b of the second ones 256b of curved fins. For instance, the distal ends 228b of the first ones 256a of curved fins can diverge toward the distal ends 228b of the second ones 256b of curved fins as they extend in a direction from the first end 204a of the heat sink 204 toward the second end 204b. The distal ends 228b of the first ones 256a of curved fins can be parallel to each other. Similarly, the distal ends 228b of the second ones 256b of curved fins can be parallel to each other. In one example, one of the first and second ends 240a and 240b of the curved fins can terminate at a longitudinal end of the heat sink 204. The other of the first and second ends 240b can terminate at one of the lateral sides of the heat sink 204 that is perpendicular to the longitudinal end. In one example, the first and second ends 240a and 240b can both be disposed at the first end 204a of the heat sink 204.

As described above, the plurality of fins 228 can include a plurality of groups of fins each defining a respective different one of the available fin geometries. In one example, a first one of the available fin geometries can be configured as the curved geometry, and a second different one of the available fin geometries can be configured as the linear geometry. In particular, the curved fins can define a gap 258 that is disposed between the divergent first and second ones 256a and 256b of the curved fins. The linear fins can be disposed in the gap 258. For instance, the linear fins can be oriented along the longitudinal direction L. Further, the distal ends 228b of different ones of the linear fins can define different lengths from their respective first end 240a to their respective second end 240b. The linear fins can extend from the second end 204b of the heat sink 204 to a location adjacent the curved fins.

Referring now to FIGS. 10A-10B, the fins 228 described herein can have geometric parameters that can allow for easy manufacturability, increase their thermal conductivity during use, or both. It should be appreciated, of course, that the fins 228 are not intended to be limited to any of these parameters unless otherwise indicated. For instance, as illustrated in FIG. 10A, one or more up to all of the fins 228 can be substantially solid, and thus include the first plastic material from one of the opposed side walls 238 to another of the opposed side walls 238, from the proximal end 228a to the distal end 228b, and along at least a majority up to an entirety of the length of the fin. The fins 228 can define a height H from the outer surface 224b to the distal end 228b. The height can be measured along the transverse direction T. In one example, the height can be in a range that is between and includes approximately 10 mm and approximately 50 mm. Further, the distal end 228b can define a thickness T along a direction perpendicular to the direction of elongation of the distal end 228b. The thickness T can, for instance, be measured from one of the opposed side walls 238 to the other of the opposed side walls 238. In one example, the thickness T can be in a range that is between and includes approximately 0.8 mm and approximately 2.0 mm.

Further, at least one or both of the opposed side walls 238 can converge toward a reference plane that is normal to the outer surface 224b at a location between the opposed side walls 238, so as to define a draft angle A with respect to the at least one or both of the opposed side walls 238 and the reference plane. The draft angle can be suitable for removal of the molded part from the mold. In one example, the draft angle can be in a range that is between and includes approximately 0.1 degree and approximately 3.0 degrees. Further, adjacent ones of the fins 228 can be spaced from each other along a pitch P, which can be defined as the center-to-center distance between adjacent ones of the fins 228. The pitch P can be in a range that is between and includes approximately 4 mm and approximately 10 mm. Additionally, the base 222 can define a thickness from the inner surface 224a to the outer surface 224b. The thickness can be in a range that is between and includes approximately 1.5 mm and approximately 3.5 mm.

Referring now to FIG. 10B, one or more up to all of the fins 228 can define a hollow interior 260, such that the fins 228 can be referred to as hollow fins. The hollow interior 260 can be defined between the opposed side walls 238. In particular, the opposed side walls 238 can define respective inner surfaces 238a that face each other, and opposed outer surfaces 238b opposite the inner surfaces 238a. The hollow interior 260 can be defined between the opposed inner surfaces 238a. Further, the hollow interior 260 can extend from the proximal end 228a to the distal end 228b. Further still, the hollow interior 260 can extend through the base 222 along the transverse direction T. The hollow interior 260 can further extend along at least a majority up to an entirety of the length of the fin 228.

The fins 228 can define a height H from the outer surface 224b to the distal end 228b. The height can be measured along the transverse direction T. In one example, the height H can be in a range that is between and includes approximately 10 mm and approximately 40 mm. Further, the distal end 228b can define a thickness T1 along a direction perpendicular to the direction of elongation of the distal end 228b. The thickness T1 can, for instance, be measured from one of the opposed side walls 238 to the other of the opposed side walls 238. In one example, the thickness T1 can be in a range that is between and includes approximately 2.5 mm and approximately 4.5 mm.

Further, at least one or both of the opposed side walls 238 can converge toward a reference plane that is normal to the outer surface 224b at a location between the respective side wall 238 and an adjacent one of the fins 228, so as to define a draft angle with respect to the at least one or both of the opposed side walls 238 and the reference plane. The draft angle A can be suitable for removal of the molded part from the mold. In one example, the draft angle can be in a range that is between and includes approximately 0.1 degrees and approximately 2.0 degrees. Further, adjacent ones of the hollow fins 228 can be spaced from each other along a pitch P, which can be defined as the center-to-center distance between adjacent ones of the fins 228. The pitch P can be in a range that is between and includes approximately 6 mm and approximately 12 mm. As described above with respect to the substantially solid fins 228, the base 222 can define a thickness from the inner surface 224a to the outer surface 224b. The thickness of the base 222 can be in a range that is between and includes approximately 1.5 mm and approximately 3.5 mm. The hollow fins can define a second thickness T2 between the inner surfaces 238a of the opposed side walls 238 at a location midway between the proximal end 228a and the distal end 228b of the fin 228, for instance, along the transverse direction T. The second thickness can be in a range that is between and includes approximately 0.8 mm and 2.0 mm.

In one example, the hollow interior 260 can remain hollow during operation of the luminaire 200. Alternatively, at least a portion up to an entirety of the hollow interior 260 can be filled with a thermally conductive paste. The thermally conductive paste can have a thermal conductivity as desired. In one example, the thermal conductivity of the thermally conductive past can have a thermal conductivity greater than that as described in connection with the second material 229b.

Referring now to FIG. 11, and as described above, the at least one group of the plurality of fins 228 can define the pin-shaped geometry so as to define pin-shaped fins. The pin-shaped fins can define a pin field 262 that includes a plurality of rows 262a of pin-shaped fins and a plurality of columns 262b of pin-shaped fins that are angularly offset with respect to the rows 262a. For instance, the columns 262b can be oriented perpendicular to the rows. The rows 262a can be oriented along the lateral direction A, and the columns 262b can be oriented along the longitudinal direction L. For instance, the rows 262a can extend to each of the opposed lateral sides of the base 222. The columns 262b can extend from the second end 204b to the longitudinal end of the first end 204a. Adjacent ones of the pin-shaped fins of the rows are spaced from each other a first distance, and adjacent ones of the pin-shaped fins of the columns are spaced from each other a second distance. The first distance can be equal to the second distance. Alternatively, the first distance can be greater than or less than the second distance. As described above, the distal ends 228b of each of the pin-shaped fins can be spaced from the respective proximal ends 228a along a central axis that is normal to the outer surface 224b of the base 222.

The at least one side wall 238 of the pin-shaped fins can define a rounded outer surface that extends between the proximal end 228a and the distal end 228b. For instance, the rounded outer surface can extends from the proximal end 228a to the distal end 228b. The rounded outer surface of the side wall 238 can thus be round along a plane that extends through the fin 228 along a direction parallel to the outer surface 224b of the base 222, which is normal to the central axis. In one example, the side wall 238 can be configured substantially as a cylinder. For instance, at least one or both of the proximal end 228a and the distal end 228b of the pin-shaped fins can be circular. Thus, each of the proximal ends 228a can define an equal length along two perpendicular lines that are oriented parallel to the outer surface 224b of the base 222, and thus can be perpendicular to the central axis. Similarly, each of the distal ends 228b can define an equal length along two perpendicular lines that are oriented parallel to the outer surface 224b of the base 222, and thus can be perpendicular to the central axis.

The at least one side wall 238 of the pin-shaped fins can further be tapered along a direction from the proximal end 228a toward the distal end 228b. For instance, at least one side wall 238 of the pin-shaped fins can be tapered from the proximal end 228a to the distal end 228b. In one example, the distal end 228b can define a maximum distance along a respective plane that is normal to the central axis. Similarly, the proximal end can define a maximum distance along a respective plane that is normal to the central axis. The maximum distance at the distal ends 228b can be in a range that is between and includes half of the maximum distance at the proximal ends 228a and an entirety of the maximum distance at the proximal ends 228a. For instance, the maximum distance at the distal end 228b can be in a range that is between and includes approximately 80 percent and the entirety of the maximum distance at the proximal ends 228a. When the proximal ends 228a and the distal ends 228b are circular in cross-section, the maximum distance can be a diameter.

Referring now to FIG. 12, and as described above, the at least one group of the plurality of fins 228 can define the pyramidal geometry so as to define pyramidal fins. The pyramidal fins can be disposed in a matrix 264 that includes a plurality of rows 264a of pyramidal fins and a plurality of columns 264b of pyramidal fins that are angularly offset with respect to the rows 264a. For instance, the columns 264b can be oriented perpendicular to the rows. The rows 264a can be oriented along the lateral direction A, and the columns 264b can be oriented along the longitudinal direction L. For instance, the rows 264a can extend to each of the opposed lateral sides of the base 222. The columns 264b can extend from the second end 204b to the longitudinal end of the first end 204a. Adjacent ones of the pyramidal fins of the rows 264a are spaced from each other a first distance, and adjacent ones of the pyramidal fins of the columns 264b are spaced from each other a second distance. The first distance can be equal to the second distance. Alternatively, the first distance can be greater than or less than the second distance. As described above, the distal ends 228b of each of the pyramidal fins can be spaced from the respective proximal ends 228a along a central axis that is normal to the outer surface 224b of the base 222.

As described above, the pyramidal fins define at least one side wall 238 that extends between the proximal end 228a and the distal end 228b. For instance, the at least one side wall 238 can extend from the proximal end 228a to the distal end 228b. In one example, the at least one side wall 238 can define at least one outer surface that can converge, or be tapered, along a direction from the proximal end 228a to the distal end 228b. For instance, the at least one outer surface can converge, or be tapered, from the proximal end 228a to the distal end 228b. In one example, the at least one outer surface can include a plurality of angled surfaces that are angled with respect to each other along a plane that extends through the pyramidal fins along a direction substantially parallel to the outer surface 224b of the base 222. The distal end 228b can define a maximum distance along two perpendicular lines that extend in a respective plane that is normal to the central axis. Thus, the distal ends 228b of the pyramidal fins can define an equal length along two perpendicular lines that are oriented parallel to the outer surface 224b of the base 222. Similarly, the proximal end 228a can define a maximum distance along two perpendicular lines that extend in a respective plane that is normal to the central axis. In one example, each of the two perpendicular lines at proximal end 228a can bisect a rectangle, such as a square, into a pair of right-angle triangles. Thus, the proximal ends 228a of the pyramidal fins can define an equal length along two perpendicular lines that are oriented parallel to the outer surface 224b of the base 222. The lengths at the distal ends 228b can be less than half the length of the proximal ends 228a. For instance, the distal ends 228b can define substantially pointed tips.

Referring to FIGS. 1A-12 generally, it should be appreciated that methods can be provided for fabricating one or both of the heat sink 204 and the luminaire 200. The method can include the step of selecting the fin geometry of the at least one of the group of available geometries, and fabricating the heat sink 204 in any manner described above. The method can further include the steps of fabricating the luminaire 200 in any manner described above.

It should be appreciated that the present disclosure can include any one up to all of the following examples:

### Example 1

A heat sink comprising:

a base that defines an inner surface configured to be placed in thermal communication with at least one LED, and an outer surface opposite the inner surface; and

a plurality of plastic fins that project out from the outer surface from a proximal end to a distal end, wherein at least one group of the plurality of fins defines a fin geometry that is selected from at least one of a group of available geometries including a linear geometry, an angled geometry, a radial geometry, a pin-shaped geometry, a pyramidal geometry, and a curved geometry.

### Example 2

The heat sink as recited in example 1, wherein the linear geometry, the angled geometry, the curved geometry, and the radial geometry are defined by a direction of elongation of the distal end of the group of the plurality of fins.

### Example 3

The heat sink as recited in any one of examples 1 to 2, wherein the at least one group of the plurality of fins comprises a first group of the plurality of fins that defines a first fin geometry that is selected from the group of available geometries, and a second group of the plurality of fins that defines a second geometry that is different than the first geometry and is selected from the group of available geometries.

### Example 4

The heat sink as recited in any one of examples 2 to 3, wherein the fin geometry is the linear geometry, the distal ends extend along respective linear paths that are parallel to each other.

### Example 5

The heat sink as recited in any one of examples 2 to 4, wherein the angled geometry includes a first portion and a second portion that extends from the first portion at a direction angularly offset with respect to the first portion.

### Example 6

The heat sink as recited in example 5, wherein the second portion is substantially perpendicular to the first portion.

### Example 7

The heat sink as recited in any one of examples 5 to 6, wherein the first portions of the group of the plurality of fins are parallel to each other.

### Example 8

The heat sink as recited in any one of examples 5 to 7, wherein the second portions of the group of the plurality of fins are parallel to each other.

### Example 9

The heat sink as recited in any one of examples 5 to 8, wherein at least some of the first portions have different lengths.

### Example 10

The heat sink as recited in any one of examples 5 to 9, wherein at least some of the second portions have different lengths.

### Example 11

The heat sink as recited in any one of examples 5 to 10, wherein the group of the plurality of fins defines a first region, and the first portions of the first region have respective first lengths that increase in a select direction.

### Example 12

The heat sink as recited in example 11, wherein the second portions of the first region have respective second lengths that increase in the select direction.

### Example 13

The heat sink as recited in any one of examples 11 to 12, wherein the group of the plurality of fins defines a second region, and the first portions of the second region have respective first lengths that decrease in the select direction.

### Example 14

The heat sink as recited in example 13, wherein the second portions of the second region have respective second lengths that decrease in the select direction.

### Example 15

The heat sink as recited in any one of examples 13 to 14, wherein the second portions are adjoined to the first portion at a junction, and the junctions of the first and second regions define first and second straight lines, respectively.

### Example 16

The heat sink as recited in example 15, wherein the first and second straight lines intersect each other.

### Example 17

The heat sink as recited in any one of examples 15 to 16, wherein at least one of the first and second straight lines is oblique with respect to an outer perimeter of the heat sink.

### Example 18

The heat sink as recited in any one of examples 15 to 17, wherein the group of the plurality of fins defines third and fourth regions, such that the junctions of the third and fourth regions define third and fourth straight lines, respectively.

### Example 19

The heat sink as recited in example 18, wherein the first and third straight lines are co-linear, and the second and fourth straight lines are co-linear.

### Example 20

The heat sink as recited in example 19, wherein the first and second lines are perpendicular to each other.

### Example 21

The heat sink as recited in any one of examples 18 to 20, wherein at least one of the third and fourth straight lines is oblique with respect to an outer perimeter of the heat sink.

### Example 22

The heat sink as recited in any one of examples 18 to 21, wherein the first, second, third, and fourth straight lines have equal lengths.

### Example 23

The heat sink as recited in any one of examples 18 to 22, wherein the first, second, third, and fourth regions does not include a fin whereby the first and second portions have equal lengths.

### Example 24

The heat sink as recited in any one of examples 5 to 22, wherein the plurality of fins does not include a fin whereby the first and second portions have equal lengths.

### Example 25

The heat sink as recited in any one of examples 22 to 24, wherein the group of the plurality of fins whose distal ends define the radial geometry are radial fins, and the distal ends of the radial fins are each elongate along respective lines that all intersect each other.

### Example 26

The heat sink as recited in example 25, wherein all of the lines extend from a common central location.

### Example 27

The heat sink as recited in example 26, wherein the common central location defines a central point, such all of the respective lines intersect each other at the central point.

### Example 28

The heat sink as recited in any one of examples 26 to 27, wherein the distal ends of the fins of the group of the plurality of fins are all spaced from the central location.

### Example 29

The heat sink as recited in any one of examples 25 to 28, wherein the distal ends of the fins of the group of the plurality of fins are circumferentially spaced from each other.

### Example 30

The heat sink as recited in example 29, wherein adjacent ones of the radial fins are angularly spaced from each other between approximately 4 degrees and approximately 10 degrees.

### Example 31

The heat sink as recited in any one of examples 29 to 30, wherein the group of the plurality of fins comprises between and including 36 and 90 radial fins circumferentially spaced from each other.

### Example 32

The heat sink as recited in any one of examples 29 to 31, wherein the distal ends of the fins of the group of the plurality of fins are equidistantly spaced from each other.

### Example 33

The heat sink as recited in any one of examples 26 to 32, wherein the distal ends of each of the radial fins defines a second end and a first end that is opposite the second end and disposed closer to the second end.

### Example 34

The heat sink as recited in example 33, wherein the first ends of the distal ends of at least some of the radial fins of the group of the plurality of radial fins are aligned along a circle.

### Example 35

The heat sink as recited in any one of examples 33 to 34, wherein the radial fins define respective lengths from the first end to the second end, and the lengths of adjacent ones of the radial fins are different than each other.

### Example 36

The heat sink as recited in any one of examples 33 to 35, wherein the second ends of at least some of the radial fins are disposed at a perimeter of the outer surface.

### Example 37

The heat sink as recited in any one of examples 33 to 36, wherein the in the radial configuration, the distal end of the each fins extends along a straight path from the first end to the second end.

### Example 38

The heat sink as recited in any one of examples 2 to 37, wherein when the at least one geometry comprises the curved geometry, the at least one group of fins comprises curved fins whose distal ends are curved along their respective lengths.

### Example 39

The heat sink as recited in example 38, wherein the at least some of the curved fins are parallel to each other along their respective distal ends.

### Example 40

The heat sink as recited in example 38 to 39, wherein the distal ends of first ones of the curved fins are parallel to each other, and the distal ends of second ones of the curved fins are parallel to each other, and the distal ends of the first ones diverge from the distal ends of the second ones along their respective lengths, so as to define a gap therebetween.

### Example 41

The heat sink as recited in any one of examples 38 to 40, wherein the first group of fins comprises the curved fins, and the second group of fins define the linear geometry.

### Example 42

The heat sink as recited in example 41, wherein the second group of fins are disposed in the gap.

### Example 43

The heat sink as recited in example 42, wherein the distal ends of the curved fins extend longer along a length than a width, and the second group of fins are oriented parallel to the length.

### Example 44

The heat sink as recited in any one of examples 38 to 43, wherein the distal end is spaced from the proximal end along a direction that is substantially normal to the outer surface.

### Example 45

The heat sink as recited in any one of examples 38 to 44, wherein the distal ends of the curved fins define first and second opposed ends, and define a variable curvature at a location between the first end and the second end.

### Example 46

The heat sink as recited in example 45, wherein the distal ends of the curved fins define a variable curvature from first end to the second end.

### Example 47

The heat sink as recited in any one of examples 1 to 46, wherein the fins that define the linear geometry, the angled geometry, the radial geometry, or the curved geometry define a height from the outer surface to the distal end in a range between and including approximately 10 mm and approximately 50 mm.

### Example 48

The heat sink as recited in example 47, wherein the distal ends of the fins that define the linear geometry, the angled geometry, the radial geometry, or the curved geometry has a width along a direction perpendicular to the direction of elongation of the distal ends in a range between and including approximately 0.8 mm and approximately 2.0 mm at the distal end.

### Example 49

The heat sink as recited in any one of examples 47 to 48, wherein the fins that define the linear geometry, the angled geometry, the radial geometry, or the curved geometry define opposed side walls that extend from the proximal end to the distal end, and at least one or both of the side walls converges toward a reference plane that is oriented normal to the outer surface in a direction from the proximal end to the distal end so as to define a draft angle with respect to the reference plane, and the draft angle is in a range between and including approximately 0.1 degree and approximately 3.0 degrees.

### Example 50

The heat sink as recited in any one of examples 47 to 49, wherein adjacent ones of the fins that define the linear geometry, the angled geometry, the radial geometry, or the curved geometry are spaced apart a center-to-center distance within a range between and including approximately 4 mm and approximately 10 mm.

### Example 51

The heat sink as recited in any one of examples 1 to 46, wherein the fins whose distal ends that define the linear geometry, the angled geometry, the radial geometry, or the curved geometry are hollow fins having opposed side walls that extend from the proximal end to the distal end, and the opposed side walls that define respective inner surfaces that face each other so as to define a hollow interior therebetween, and respective outer surfaces opposite the inner surfaces.

### Example 52

The heat sink as recited in example 51, wherein the inner surfaces of the hollow fins converge toward each other along a direction from the proximal end to the distal end.

### Example 53

The heat sink as recited in example 52, wherein at least one or both of the inner surfaces of the hollow fins defines an angle with respect to a plane that is normal to the outer surface of the base, the angle in a range between and including approximately 0.1 degrees and approximately 2.0 degrees.

### Example 54

The heat sink as recited in any one of examples 51 to 53, wherein the distal ends of the hollow fins have a thickness at the distal tip along a direction normal to the elongation of the distal tip, the thickness within a range between and including approximately 2.5 mm and approximately 4.5 mm.

### Example 55

The heat sink as recited in any one of examples 51 to 54, wherein the hollow fins define a height from the proximal ends to the distal ends within a range between and including approximately 10 mm and approximately 40 mm.

### Example 56

The heat sink as recited in any one of examples 51 to 55, wherein adjacent ones of the hollow fins are spaced apart a center-to-center distance within a range between and including approximately 6 mm and approximately 12 mm.

### Example 57

The heat sink as recited in any one of examples 51 to 56, wherein the hollow fins define a thickness between the inner surfaces of the opposed side walls at a location midway between the proximal end and the distal end of the fin, wherein the thickness is in a range between and including approximately 0.8 mm and 2.0 mm.

### Example 58

The heat sink as recited in any one of examples 51 to 57, wherein the hollow interior is filled with a thermally conductive paste.

### Example 59

The heat sink as recited in any one of examples 1 to 58, wherein the fins having the pin-shaped geometry are arranged in a pin field that includes rows of pin-shaped fins and columns of pin-shaped fins that are angularly offset with respect to the rows.

### Example 60

The heat sink as recited in example 59, wherein the columns are oriented perpendicular to the rows.

### Example 61

The heat sink as recited in any one of examples 59 to 60, wherein the distal ends of each of the pin-shaped fins are spaced from the proximal end along a direction that is normal to the outer surface.

### Example 62

The heat sink as recited in any one of examples 59 to 61, wherein each of the pin-shaped fins define at least one outer surface from the proximal end to the distal end.

### Example 63

The heat sink as recited in example 62, wherein the at least one outer surface is a round outer surface.

### Example 64

The heat sink as recited in example 63, wherein the at least one outer surface is a substantially cylindrical outer surface.

### Example 65

The heat sink as recited in any one of examples 59 and 64, wherein adjacent ones of the pin-shaped fins of the rows are spaced from each other a first distance, adjacent ones of the pin-shaped fins of the columns are spaced from each other a second distance, and the first distance is equal to the second distance.

### Example 66

The heat sink as recited in any one of examples 59 to 65, wherein each of the proximal ends of the group of the plurality of fins defines an equal length along two perpendicular lines that are oriented parallel to the outer surface.

### Example 67

The heat sink as recited in example 66, wherein each of the distal ends of the group of the plurality of fins defines an equal length along two perpendicular lines that are oriented parallel to the outer surface.

### Example 68

The heat sink as recited in example 67, wherein the each of the distal ends defines a maximum distance along a respective plane that is parallel to the outer surface of the base, and each of the proximal ends defines a maximum distance along a respective plane that is parallel to the outer surface of the base, wherein the maximum distance of the distal end is in a range between and including half the maximum distance of the proximal ends and an entirety of the maximum distance of the proximal ends.

### Example 69

The heat sink as recited in example 68, wherein the maximum distance at each of the distal ends is between 80 percent and the entirety of the maximum distance of the proximal ends.

### Example 70

The heat sink as recited in any one of examples 59 to 69, wherein the distal ends of the pin-shaped fins are substantially circular.

### Example 71

The heat sink as recited in any one of examples 2 to 70, wherein the fins whose distal ends define the pyramidal geometry are pyramidal fins arranged in a matrix that includes rows of pyramidal fins and columns of pyramidal fins that are angularly offset with respect to the rows.

### Example 72

The heat sink as recited in example 71, wherein the columns of the matrix are oriented perpendicular to the rows of the matrix.

### Example 73

The heat sink as recited in any one of examples 71 to 72, wherein the distal ends of each of the pyramidal fins are spaced from the proximal end along a direction that is normal to the outer surface.

### Example 74

The heat sink as recited in any one of examples 71 to 73, wherein each of the pyramidal fins defines at least one outer surface that converges from the proximal end to the distal end.

### Example 75

The heat sink as recited in example 74, wherein the at least one outer surface comprises a plurality of angled surfaces that are angled with respect to each other along a plane that extends through the pyramidal fins along a direction substantially parallel to the outer surface.

### Example 76

The heat sink as recited in any one of examples 71 to 75, wherein adjacent ones of the pyramidal fins of the rows of the matrix are spaced from each other a first distance, adjacent ones of the pyramidal fins of the columns of the matrix are spaced from each other a second distance, and the first distance is equal to the second distance.

### Example 77

The heat sink as recited in any one of examples 71 to 76, wherein each of the proximal ends of the group of the pyramidal fins defines an equal length along two perpendicular lines that are oriented parallel to the outer surface.

### Example 78

The heat sink as recited in example 77, wherein each of the distal ends of the group of the plurality of fins defines an equal length along two perpendicular lines that are oriented parallel to the outer surface.

### Example 79

The heat sink as recited in example 78, wherein the length at each of the distal ends is less than half the length at each of the proximal ends.

### Example 80

The heat sink as recited in example 79, wherein the distal ends define substantially pointed tips.

### Example 81

The heat sink as recited in any one of examples 1 to 80, wherein the base has a thickness from the inner surface to the outer surface in a range between and including approximately 1.5 mm and approximately 3.5 mm.

### Example 82

The heat sink as recited in any one of examples 1 to 81, wherein the fins are continuous along their respective directions of elongation.

### Example 83

The heat sink as recited in any one of examples 1 to 82, wherein the fins are continuous from their proximal ends to their distal ends.

### Example 84

The heat sink as recited in any one of examples 1 to 83, wherein the distal ends of the fins are free ends.

### Example 85

The heat sink as recited in any one of examples 1 to 84, wherein fins are made from a plastic material.

### Example 86

The heat sink as recited in example 85, wherein the plastic material is a thermoplastic.

### Example 87

The heat sink as recited in example 86, wherein the plastic material of the fins has a through-plane thermal conductivity within a range of approximately 0.5 and approximately 5 W/m-k.

### Example 88

The heat sink as recited in any one of examples 85 to 87, wherein the outer surface is made from the plastic material.

### Example 89

The heat sink as recited in any one of examples 85 to 88, wherein the fins are monolithic with the outer surface.

### Example 90

The heat sink as recited in any one of examples 85 to 89, wherein an entirety of the heat sink is made from the plastic material.

### Example 91

The heat sink as recited in any one of examples 85 to 90, wherein the fins are monolithic with the base.

### Example 92

The heat sink as recited in any one of examples 85 to 89, wherein the plastic material comprises of the fins comprises a first plastic material, and the base further comprises a second plastic material different than the first plastic material.

### Example 93

The heat sink as recited in example 92, wherein a first portion of the base and a first portion of the plurality of fins comprises the first plastic material, and a second portion of the base different than the first portion of the base comprises the second plastic material.

### Example 94

The heat sink as recited in example 93, wherein at least a portion of the first portion is surrounded by at least a portion of the second portion.

### Example 95

The heat sink as recited in example 94, wherein the first portion is surrounded by the second portion.

### Example 96

The heat sink as recited in example 93, wherein the first plastic material has a first thermal conductivity, and the second plastic material has a second thermal conductivity less than the first thermal conductivity.

### Example 97

The heat sink as recited in any one of examples 93 to 96, wherein the first plastic material has a through-plane thermal conductivity within a range of approximately 0.5 and approximately 5 W/m-k.

### Example 98

The heat sink as recited in any one of examples 93 to 97, wherein all of the fins are supported by the second portion.

### Example 99

The heat sink as recited in any one of examples 93 to 97, wherein the plurality of fins combine to define a surface area, and the first portion carries more of the surface area than the second portion.

### Example 100

The heat sink as recited in any one of examples 93 to 97, wherein the first portion is monolithic with the second portion.

### Example 101

The heat sink as recited in example 100, wherein the first portion is co-injected with the second portion.

### Example 102

The heat sink as recited in any one of examples 93 to 97, wherein the first portion is attached to the second portion.

### Example 103

The heat sink as recited in any one of examples 93 to 102, wherein the first plastic material comprises a thermoplastic, and the second plastic material comprises a thermoplastic.

### Example 104

The heat sink as recited in any one of examples 85 to 89, wherein the heat sink further comprises an electrically conductive material.

### Example 105

The heat sink as recited in example 104, wherein the electrically conductive material comprises a metal.

### Example 106

The heat sink as recited in example 105, wherein the base comprises a metal.

### Example 107

The heat sink as recited in any one of examples 105 to 106, wherein at least a portion of the inner surface of the base is defined by the metal.

### Example 108

The heat sink as recited in any one of examples 105 to 107, wherein the metal is substantially encapsulated by the plastic material.

### Example 109

The heat sink as recited in any one of examples 104 to 108, wherein the metal is overmolded by the plastic material.

### Example 110

The heat sink as recited in any one of examples 105 to 109, wherein the metal comprises a metal plate.

### Example 111

The heat sink as recited in any one of examples 1 to 87, wherein the outer surface of the base is spaced from the inner surface of the base along a transverse direction, and the base comprises a first end and a second end opposite the first end along a longitudinal direction that is perpendicular to the transverse direction, wherein the first end comprises the plastic material, the fins project out from the outer surface at the first end, and the outer surface is substantially smooth at the second end.

### Example 112

The heat sink as recited in example 111, wherein the second end is plastic.

### Example 113

The heat sink as recited in example 112, wherein the second end comprises the plastic material.

### Example 114

The heat sink as recited in example 113, wherein the second end comprises a plastic material different than the plastic material.

### Example 115

The heat sink as recited in example 114, wherein the plastic material of the second end has a lower thermal conductivity than the plastic material of the fins.

### Example 116

The heat sink as recited in any one of examples 111 to 115, wherein the plastic material of the second end is monolithic with the plastic material of the first end.

### Example 117

The heat sink as recited in example 116, wherein the first end and the second end are co-injected.

### Example 118

The heat sink as recited in example 111, wherein the second end is electrically conductive.

### Example 119

The heat sink as recited in example 118, wherein the second end is metallic.

### Example 120

The heat sink as recited in any one of examples 111 to 119, wherein the first and second ends are attached to each other.

### Example 121

The heat sink as recited in example 120, wherein the first end includes at least one first attachment member, and the second end includes at least one second attachment member that is configured to mate with the at least one first attachment member so as to attach the first and second ends to each other.

### Example 122

The heat sink as recited in any one of examples 121 to 121, wherein the outer surface of the base at the second end is substantially coplanar with the distal ends of the fins.

### Example 123

The heat sink as recited in any one of examples 111 to 122, wherein the first end comprises first and second sides spaced from each other along a lateral direction that is perpendicular to both the transverse direction and the longitudinal direction, the plurality of fins includes first ones that project out from the outer surface at the first side, and second ones that project out from the outer surface at the second side.

### Example 124

The heat sink as recited in example 123, wherein the group of the plurality of fins includes the first and second ones of the plurality of fins.

### Example 125

The heat sink as recited in any one of examples 123 and 124, wherein the first and second sides are monolithic with each other.

### Example 126

The heat sink as recited in any one of examples 123 to 124, wherein the first side and the second side are attached to each other.

### Example 127

The heat sink as recited in any one of examples 123 to 126, wherein the first side includes at least one attachment member, the second side includes at least one attachment member, and the second end includes at least a pair of attachment members that are configured to attach to respective ones of the at least one attachment member of the first side and the at least one attachment member of the second side, so as to attach each of the first and second sides to the second end.

### Example 128

A luminaire comprising: a housing component that includes a lens;
the heat sink as recited in any one of examples 1 to 120 at least partially supported by the housing component such that an interior space is disposed between the at least one housing component the heat sink; and an LED panel disposed in the interior space, the LED panel including at least one LED configured to produce illumination, such that at least a portion of the illumination is directed through the lens.

### Example 129

The luminaire as recited in example 128, wherein a straight line extending through the lens and the LED panel also passes through one of the fins.

### Example 130

The luminaire as recited in any one of examples 128 to 129, wherein the LED panel includes an LED substrate and the at least one LED supported by the LED substrate, wherein the LED substrate is disposed between the at least one LED and the fins.

### Example 131

The luminaire as recited in any one of examples 128 to 130, wherein the heat sink is attached to the housing component such that the interior space is defined by the heat sink and the housing component.

### Example 132

A luminaire comprising: a housing component that defines a first end and a second end spaced from the first end, wherein the housing component includes a lens;

the heat sink as recited in any one of examples 111 to 122 at least partially supported by the housing component such that an interior space is disposed between the at least one housing component the heat sink, wherein the first end of the heat sink is aligned with the first end of the housing, and the second end of the heat sink is aligned with the second end of the housing;

a driver disposed in the interior space at the second end of the heat sink; and

an LED panel disposed in the interior space at the first end of the heat sink, the LED panel including at least one LED in electrical communication with the driver and configured to produce illumination, such that at least a portion of the illumination is directed through the lens.

### Example 133

The luminaire as recited in example 132, wherein a straight line extending through the lens and the LED panel also passes through one of the fins.

### Example 134

The luminaire as recited in any one of examples 132 to 133, wherein the LED panel includes an LED substrate and the at least one LED supported by the LED substrate, wherein the LED substrate is disposed between the at least one LED and the fins.

### Example 135

The luminaire as recited in any one of examples 132 to 134, wherein the heat sink is attached to the housing so as to define the interior space between the heat sink and the housing, wherein the first end of the housing is aligned with the first end of the heat sink, and the second end of the housing is aligned with the second end of the heat sink.

### Example 136

A luminaire comprising: a housing component that defines a first end and a second end, wherein the first end defines a first side that includes a first lens, and a second side that includes a second lens;

the heat sink as recited in any one of examples 123 to 127 at least partially supported by the housing component such that an interior space is disposed between the at least one housing component the heat sink, wherein the first side of the heat sink is aligned with the first side of the housing component, the second side of the heat sink is aligned with the second side of the housing component, and the second end of the heat sink is aligned with the second end of the housing component;

a driver disposed in the interior space at the second end of the housing component;

a first LED panel disposed in the interior space between the first side of the housing component and the first side of the heat sink, the first LED panel including at least one first LED in electrical communication with the driver and configured to produce illumination, such that at least a portion of the illumination is directed through the first lens; and a second LED panel disposed in the interior space between the second side of the housing component and the second side of the heat sink, the second LED panel including at least one second LED in electrical communication with the driver and configured to produce illumination, such that at least a portion of the illumination is directed through the second lens.

### Example 137

The luminaire as recited in example 136, wherein a straight line extending through the first lens and the first LED panel also passes through a fin of the first side of the heat sink.

### Example 138

The luminaire as recited in any one of examples 136 to 137, wherein a second straight line extending through the second lens and the second LED panel also passes through a fin of the second side of the heat sink.

### Example 139

The luminaire as recited in any one of examples 136 to 138, wherein the heat sink is attached to the housing so as to define the interior space between the heat sink and the housing.

### Example 140

A method of fabricating the heat sink as recited in any one of examples 1 to 127, the method comprising the step of selecting the fin geometry of the at least one of the group of available geometries.

### Example 141

A method of fabricating the luminaire as recited in any one of examples 128 to 131, the method comprising the step of selecting the fin geometry of the at least one of the group of available geometries.

### Example 142

A method of fabricating the luminaire as recited in any one of examples 132 to 135, the method comprising the step of selecting the fin geometry of the at least one of the group of available geometries.

### Example 143

A method of fabricating the luminaire as recited in any one of examples 136 to 139, the method comprising the step of selecting the fin geometry of the at least one of the group of available geometries.

The foregoing description is provided for the purpose of explanation and is not to be construed as limiting the invention. While various embodiments have been described with reference to preferred embodiments or preferred methods, it is understood that the words which have been used herein are words of description and illustration, rather than words of limitation. Furthermore, although the embodiments have been described herein with reference to particular structure, methods, and embodiments, the invention is not intended to be limited to the particulars disclosed herein. For instance, it should be appreciated that structure and methods described in association with one embodiment are equally applicable to all other embodiments described herein unless otherwise indicated. Those skilled in the relevant art, having the benefit of the teachings of this specification, may effect numerous modifications to the invention as described herein, and changes may be made without departing from the spirit and scope of the invention, for instance as set forth by the appended claims.

1. A heat sink comprising:
a base that defines an inner surface configured to be placed in thermal communication with at least one LED, and an outer surface opposite the inner surface; and
a plurality of plastic fins that project out from the outer surface from a proximal end to a distal end, wherein at least one group of the plurality of fins defines a fin geometry that is selected from at least one of a group of available geometries including a linear geometry, an angled geometry, a radial geometry, a pin-shaped geometry, a pyramidal geometry, and a curved geometry,
wherein the linear geometry, the angled geometry, the curved geometry, and the radial geometry are defined by a direction of elongation of the distal end of the group of the plurality of fins along the outer surface.

2. The heat sink as recited in claim 1, wherein the at least one group of the plurality of fins comprises a first group of the plurality of fins that defines a first fin geometry that is selected from the group of available geometries, and a second group of the plurality of fins that defines a second geometry that is different than the first geometry and is selected from the group of available geometries.

3. The heat sink as recited in claim 1, wherein fins are made from a plastic material having a through-plane thermal conductivity within a range of approximately 0.5 and approximately 5 W/m-k.

4. The heat sink as recited in claim 1, wherein the fins are monolithic with the outer surface.

5. The heat sink as recited in claim 1, wherein the plastic material comprises of the fins comprises a first plastic material, and the base further comprises a second plastic material different than the first plastic material.

6. The heat sink as recited in claim 1, wherein the base comprises a metal.

7. The heat sink as recited in claim 1, wherein when the distal ends of the fins define the linear geometry, the angled geometry, the radial geometry, or the curved geometry, the fins are hollow fins having opposed side walls that extend from the proximal end to the distal end, and the opposed side walls that define respective inner surfaces that face each other so as to define a hollow interior therebetween, and respective outer surfaces opposite the inner surfaces.

8. The heat sink as recited in claim 1, wherein when the fins define the linear geometry, the angled geometry, the radial geometry, or the curved geometry, the fins define a height from the outer surface to the distal end in a range between and including approximately 10 mm and approximately 50 mm.

9. The heat sink as recited in claim 1, wherein when the fins have the pin-shaped geometry, the pins are arranged in a pin field that includes rows of pin-shaped fins and columns of pin-shaped fins that are angularly offset with respect to the rows.

10. The heat sink as recited in claim 1, wherein the base has a thickness from the inner surface to the outer surface in a range between and including approximately 1.5 mm and approximately 3.5 mm.

11. A luminaire comprising:
a housing component that includes a lens;
the heat sink as recited in claim 1 at least partially supported by the housing component such that an interior space is disposed between the at least one housing component the heat sink; and
an LED panel disposed in the interior space, the LED panel including at least one LED configured to produce illumination, such that at least a portion of the illumination is directed through the lens.
